(19) United States
(12) Patent Application Publication
(10) Pub. No.: US 2016/0370960 A1
(43) Pub. Date: Dec. 22, 2016

(54) ELECTRONIC DEVICE INCLUDING TOUCH SCREEN DISPLAY FOR PROCESSING FILE INSTRUCTIONS SIMULTANEOUSLY AND METHOD OF OPERATING SAME

(71) Applicant: NHN Entertainment Corporation, Seongnam-si (KR)

(72) Inventor: Changyol BAEK, Seongnam-si (KR)

(21) Appl. No.: 15/181,627

(22) Filed: Jun. 14, 2016

(30) Foreign Application Priority Data
Jun. 16, 2015 (KR) 10-2015-0085113

(51) Int. Cl. G06F 3/0482; G06F 3/0488; G06F 3/0481; G06F 3/0484

(52) U.S. Cl. CPC G06F 3/0482; G06F 3/04845; G06F 3/04883; G06F 3/04817

(57) ABSTRACT

An electronic device having a touch screen display and a method of operating the device in which the touch screen displays objects representative of a plurality of files, with each of the objects extending generally in a first direction and arranged in a second direction intersecting the first direction. A file selection mode enables selecting at least two of the objects representative of files in response to receiving a first user input. A second user input in the form of a user touching, e.g., dragging, the at least two objects in the second direction determines target files. A third user input selects an instruction to be carried out simultaneously on the target files and a processor executes the selected instruction for the target files.

### CROSS REFERENCE TO RELATED APPLICATION

This application claims priority from and the benefit of Korean Patent Application No. 10-2015-0085113, filed on Jun. 16, 2015, which is hereby incorporated by reference for all purposes as if fully set forth herein.

### BACKGROUND

Field

Exemplary embodiments of the inventive concepts relate generally to an electronic device including a touch screen display and a method of operating same, and, more particularly, to an electronic device including a touch screen display having improved functionality in the way files are selected from a plurality of files and a process instruction on the selected files are executed simultaneously.

Discussion of the Background

Electronic devices, such as a smartphone, tablet PC, and personal digital assistant (PDA), may include a touch screen display, so that a user may conveniently use and control the electronic device by touching a graphical user interface (GUI) displayed on the touch screen display. Since the electronic devices may communicate with other electronic devices or servers through wireless communication networks, users of the electronic devices may exchange files or messages each other almost anywhere. For example, a user of the electronic device (smartphone or tablet PC) may access a mail server or a Social Network Service (SNS) server to send messages to other users or receive messages from other users.

The electronic device may provide various file management functions, including message management functions, which are controlled by touching the touch screen display. Such file management functions may include deleting file(s), copying file(s), cutting file(s), sending file(s), and moving file(s). Similar functions may be provided for message management functions. For example, a user may delete some messages stored in the mail server and SNS server using GUI displayed on the touch screen display. However, the user may have to select each message to be deleted in a singular fashion, one-by-one, and then select a menu for deleting messages. Such methods may be inconvenient for the users, where so many messages and files are exchanged between users, and do not use computer processing power efficiently.

The above information disclosed in this Background section is only for enhancement of understanding of the context of the inventive concept, and, therefore, it may contain information that does not form the prior art that is already known in this country to a person of ordinary skill in the art.

### SUMMARY

Exemplary embodiments overcome the above-referenced drawbacks by providing an electronic device with a touch screen display that facilitates user selection and computer processing of multiple files simultaneously.

In one exemplary embodiment a method of operating an electronic device having a touch screen display includes the steps of: displaying objects representative of a plurality of files, each of the objects extending generally in a first direction and arranged in a second direction intersecting the first direction; providing a file selection mode for selecting at least two of the objects representative of files in response to receiving a first user input; receiving a second user input that includes the user touching the at least two objects in the second direction to determine target files; and selecting via a third user input an instruction to be carried out simultaneously on the target files and executing the selected instruction for the target files.

The first user input may include the user touching one of the objects. The second user input may include selecting at least one of the objects by dragging the at least one object along a path in the second direction.

The first use input may include dragging one of the objects farther than a threshold distance in the first direction.

The first and second user inputs may include a continuous motion.

The first user input may include touching and holding one of the objects longer than a predetermined time.

The first user input may include touching a position of the touch screen display in a location other than the locations of the objects.

The second user input may include a vector element in the second direction.

The step of selecting via a third user input an instruction to be carried out simultaneously on the target files and executing the selected instruction for the target files may include: displaying an execution menu including at least one item associated with a file management function corresponding to an instruction for processing the file management function for a user to select; determining, in response to the third user input, a file process instruction associated with the selected function; and processing the file process instruction for the target files.

The execution menu may be displayed after the conclusion of the second user input.

The execution menu may include at least one of an item to delete the selected files, an item to copy the selected files, and an item to send the selected files.

The execution menu may include an item for canceling selection of at least one of the target objects.

In another exemplary embodiment an electronic device includes a touch screen display and a processor configured to process an instruction for target files, each of the plurality of files including an object representative of the file and extending generally in a first direction on the touch screen display, with the plurality of objects being arranged in a second direction intersecting the first direction on the touch screen display. The processor includes a user input processing module for detecting a first user input of user touching an object on the touch screen display and detecting a second user input that includes the user touching the object in the second direction on the touch screen display; a service initiating module for providing, in response to the first user input, a file selection mode for selecting at least two target objects from the plurality of objects; and an execution module for determining the target files corresponding to the target objects responsive to the second user input, determining a user instruction for simultaneously processing the target files and executing the instruction according to the user instruction.

The processor may be configured to display an execution menu including at least one item associated with a file management function corresponding to an instruction for processing the file management function for a user to select via a third user input. The execution module may be configured to: determine, in response to the third user input, a file process instruction associated with the selected function; and process the file process instruction for the target files.

According to yet another exemplary embodiment a non-transitory computer-readable storage medium stores a program which, when executed by a computer, performs the steps of: displaying, via a touch screen display, objects representative of a plurality of files, each of the objects extending generally in a first direction and arranged in a second direction intersecting the first direction; providing a file selection mode for selecting at least two of the objects representative of files in response to receiving a first user input via the touch screen display; receiving, via the touch screen display, receiving a second user input that includes touching the at least two objects in the second direction to determine target files; and selecting via a third user input an instruction to be carried out simultaneously on the target files and executing the selected instruction for the target files.

Additional aspects of the inventive concepts will be set forth in the detailed description which follows, and, in part, will be apparent from the disclosure, or may be learned by practice of the inventive concept.

The foregoing general description and the following detailed description are exemplary and explanatory and are intended to provide further explanation of the claimed subject matter, which is defined solely by the appended claims.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a flow chart illustrating an improved file selection and process instruction method for operating an electronic device including a touch screen display constructed according to principles of the invention.

FIG. 2 is an exemplary screenshot of a touch screen display constructed according to an exemplary embodiment illustrating multiple objects representative of files and receipt of a first input to cause the device to enter into a file selection mode of the invention according to an exemplary embodiment employing a dragging motion in a first direction.

FIG. 3 is an exemplary screenshot of the touch screen display of FIG. 2 illustrating receipt of a first input to cause the device to enter into a file selection mode according to another exemplary embodiment employing a touch and hold motion.

FIG. 4 is an exemplary screenshot of the touch screen display of FIG. 2 illustrating receipt of a first input to cause the device to enter into a file selection mode t according to still another exemplary embodiment employing a touch motion.

FIG. 5 is an exemplary screenshot of the touch screen display of FIG. 2 illustrating receipt of a second input according to an exemplary embodiment employing a dragging motion across selected objects in a second direction transverse the first direction.

FIG. 6 is a flow chart schematically illustrating the simultaneous processing steps in S500 of FIG. 1.

FIG. 7 and FIG. 8 are screenshots of the touch screen display of FIG. 2 illustrating exemplary execution menus that may be displayed to carry out exemplary process instructions on the selected files.

FIG. 9 is a block diagram illustrating a structure of an electronic device construction according to an exemplary embodiment of the invention.

FIG. 10 is a system including the electronic device and a server communicating with the electronic device over a network.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. The regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

In the specification and claims, the following terms have the meaning provided herein: “touching” refers to any action or gesture performed by a user on a touch screen display (“TSD”), such as contacting the TSD with a finger, stylus, electronic pen or other tool (“touch tool”) to control a device operably connected to the TSD.

“Touching and holding” refers to a user's touching a TSD and then maintaining the action for a predetermined threshold time after touching the screen. In other words, “touching and holding” occurs when the difference in time between first starting the touching (“touch-in time”) and ending the touching (“touch-out time”) is greater than or equal to the predetermined threshold time, for example, 2 secs. When the time difference is greater than the threshold time, a feedback signal may be provided in a visual, acoustic, or tactile manner to remind the user whether the touching is touching and holding. The threshold time may vary according to specific implementations.

“Dragging” is a user's motion of touching the screen by using the finger or touch tool and moving the finger or touch tool to another position on the screen while maintain the touching, e.g., by maintaining contact with the screen. The dragging may enable the moving or panning motion of an object.

A method for simultaneously processing an instruction for plurality of files according to the principles of the invention may be performed by an electronic device including a touch screen display. The electronic device may include a mobile phone, a smartphone, a tablet PC, a personal digital assistant (PDA), an electronic book terminal, a digital broadcast terminal, a portable multimedia player (PMP), a navigation device, an MP3 player, a digital camera, a wearable device, etc., and other devices that may be controlled by a TSD

Hereinafter, the improved file selection and simultaneous processing methods according to exemplary embodiments of the invention will be described in detail.

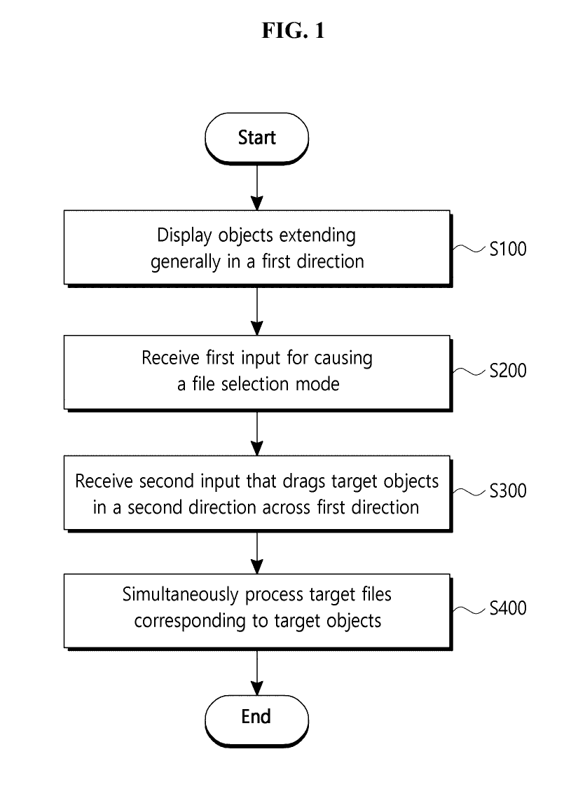

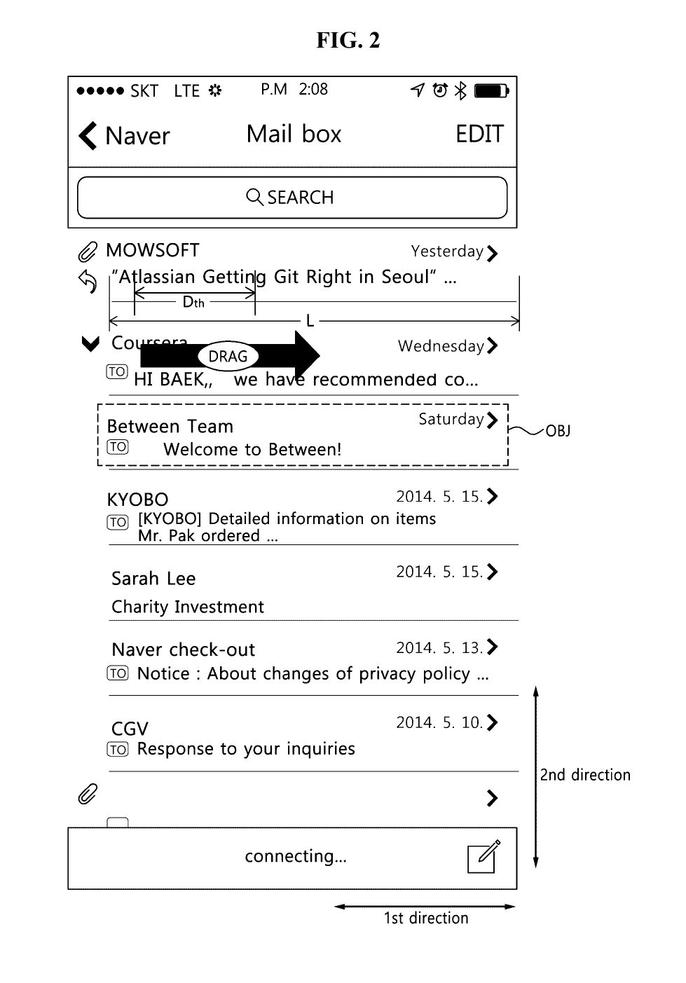

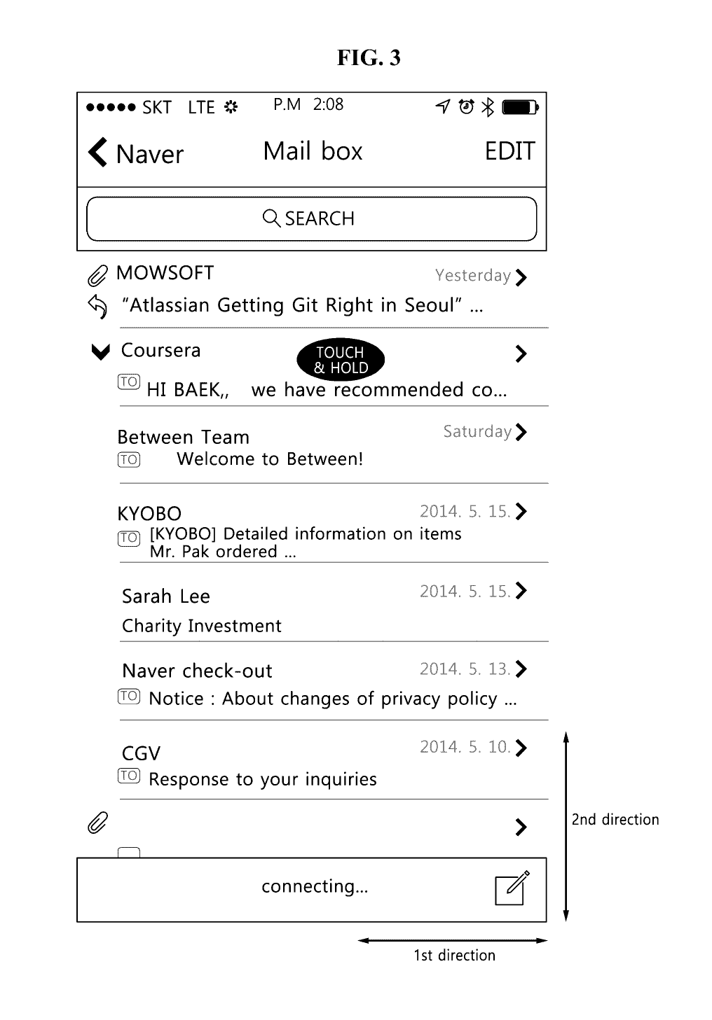

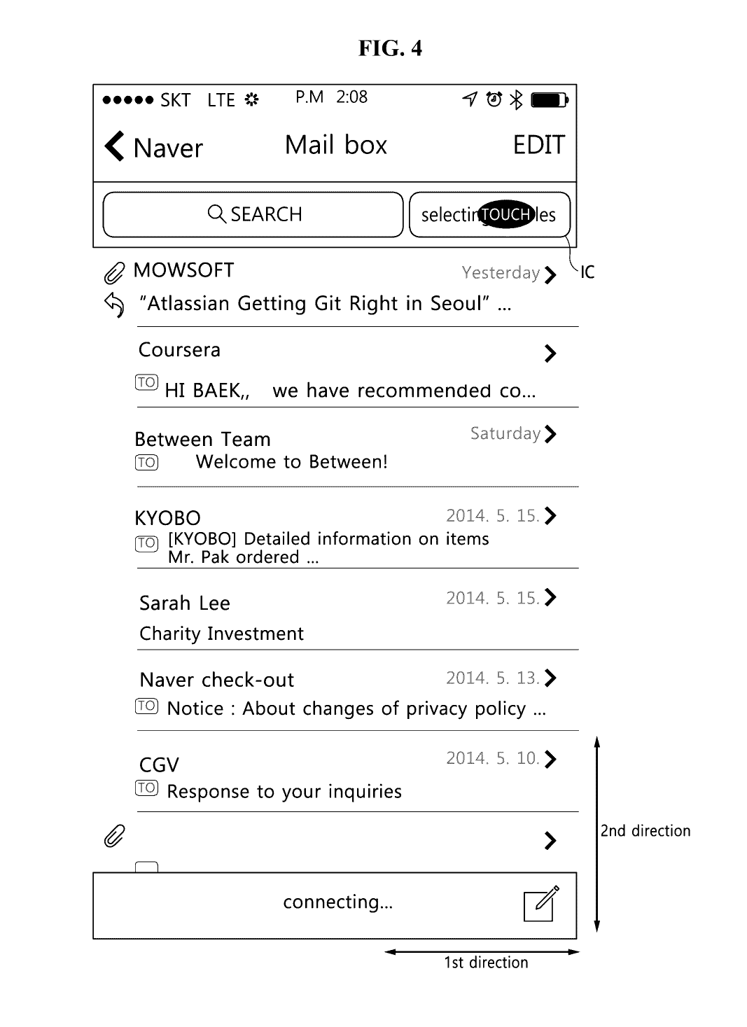

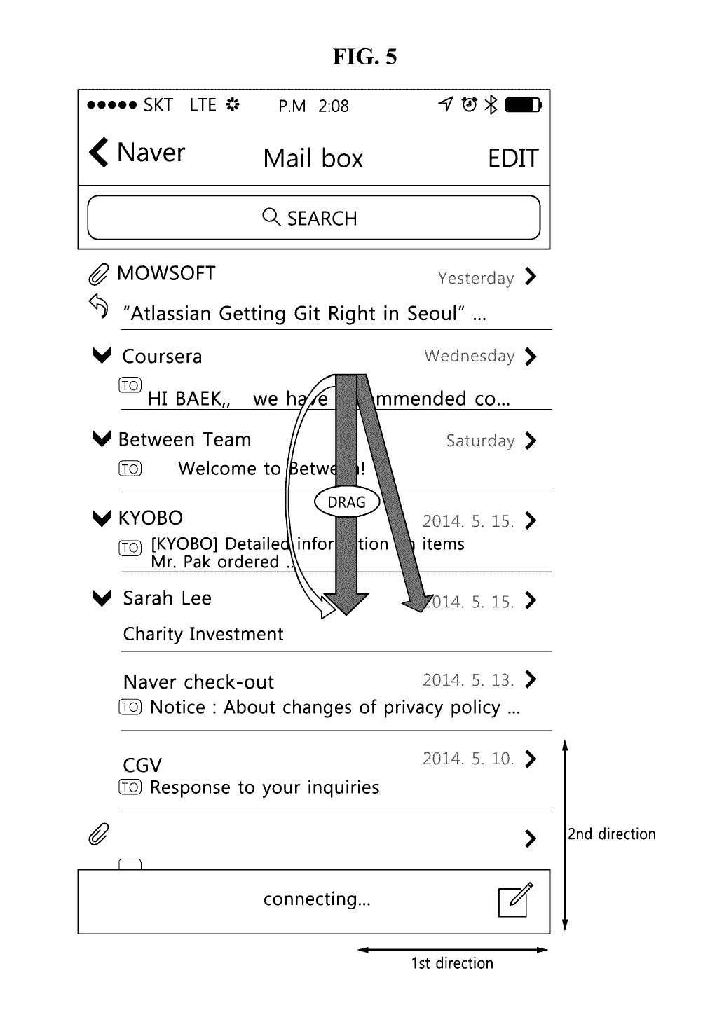

FIG. 1 is a flow chart illustrating an improved file selection and process instruction method for operating an electronic device including a touch screen display. FIG. 2 is an exemplary screenshot of a touch screen display constructed according to an exemplary embodiment illustrating multiple objects representative of files and receipt of a first input to cause the device to enter into a file selection mode according to an exemplary embodiment employing a dragging motion in a first direction. FIG. 3 is an exemplary screenshot of the touch screen display of FIG. 2 illustrating receipt of a first input to cause the device to enter into a file selection mode according to another exemplary embodiment employing a touch and hold motion. FIG. 4 is an exemplary screenshot of the touch screen display of FIG. 2 illustrating receipt of a first input to cause the device to enter into a file selection mode t according to still another exemplary embodiment employing a touch motion. FIG. 5 is an exemplary screenshot of the touch screen display of FIG. 2 illustrating receipt of a second input according to an exemplary embodiment employing a dragging motion across selected objects in a second direction transverse the first direction.

Referring to FIG. 1, at step 5100, an electronic device displays objects that generally extend in a first direction along the touch screen display. The first direction is shown in FIG. 2 as being the generally horizontal direction across the width of the display. The objects may correspond to a plurality of files stored, for example, the electronic device, a mail server communicating the electronic device, or a Social Network Service (SNS) server. Each object OBJ may represent information of a corresponding file, such as title of a message, a part of the message, or file information.

Each file may be at least one of a message file of an email account, a message file of an online messenger, and a message file of a social network service (SNS) account, or similar files. The file may be any type such as at least one of a document file, a multimedia file, and the like.

At step S200, the electronic device receives a first input from the TSD to initiate the device to enter a file selection mode. The file selection mode may permit selection of at least two files from the plurality of files represented by the objects displayed at step S100. The step S200 may include determining a reference file from the plurality of files in response to the first input that a user touches on a reference object corresponding to the reference file. In other words, the step S200 may be initiated when a user touches one or more of the reference objects displayed on the touch screen display.

More specifically, referring to FIG. 2, the first input may be an input that drags one of the objects on the TSD in the first direction generally along the length of the object farther than a predetermined threshold distance Dth. When this occurs, the electronic device then may determine the one object as being the reference object. The predetermined threshold distance Dth, for example, may be ⅕ to ½ of a displayed length L of the object OBJ in the first direction.

Referring to FIG. 3, the first input is an input that touches and holds one of the objects longer than a predetermined threshold time. When this occurs, the electronic device then may determine the one object as being the reference object. The predetermined threshold time, for example, may be 1 to 2 seconds.

Referring to FIG. 4, the electronic device may further display an icon IC associated with the file selection mode on a certain position of the touch screen display when objects are displayed. In this case, the first input may be an input that touches the icon IC at certain position of the touch screen display.

As described above, erroneous initiation of the file selection mode may be prohibited because the file selection mode is not triggered until after receipt of the first input. For example, the file selection mode may be initiated by dragging farther than the threshold distance or by touching and holding longer than the threshold time. In a normal mode, objects may not be selected as target objects even though a second input to initiate another action, such as an instruction to delete or forward a file, is received. In the file selection mode, objects may only be selected as the target objects when the second input is received.

Referring back to FIG. 1, at step S300, the electronic device receives a second user input that comprises a user touching, e.g., dragging, the target objects in a second direction across the first direction. The electronic device may determine target objects based on the second input. The second direction may extend generally vertically up and down to intersect or extend across the first direction. For instance, the second direction may be extend perpendicular to the first direction.

For example, the second input may comprise dragging one or more objects across other objects in the second direction. The target objects may be selected by the user by dragging is along a path extending across the first direction. In case that the first input is an input that drags in the first direction as described with reference to FIG. 2 or the first input is an input that touches and holds as described with reference to FIG. 3, the target objects may include the reference object.

The second input may include a vector element in the second direction. Referring to FIG. 5, objects crossing the first direction may be selected not only by dragging straightly, but also by dragging curvedly or dragging diagonally, which include the vector element in the second direction.

For example, the electronic device may display the target objects distinctively from the other objects in the touch screen display.

At step S400, the electronic device may simultaneously process all target files corresponding to the target objects according to a single instruction. The electronic device may determine an instruction based on a third input, and perform the instruction for all the target files, including deleting, storing, forwarding or any other action the process of the electronic device may be programmed to do.

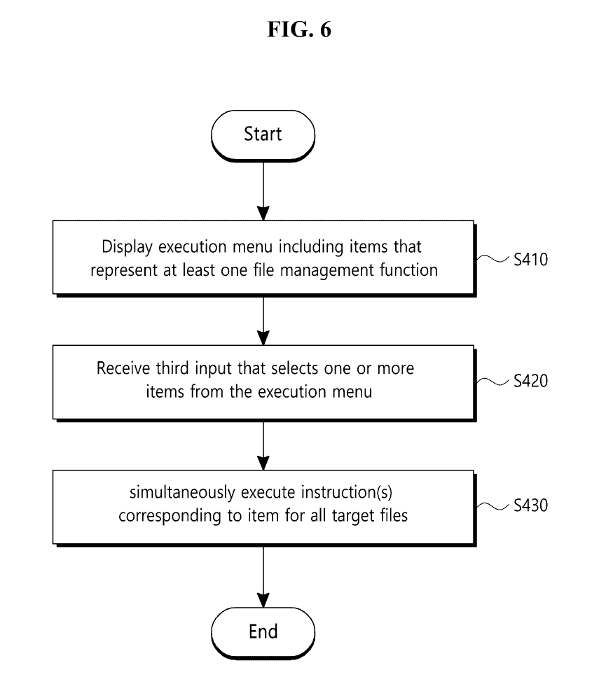

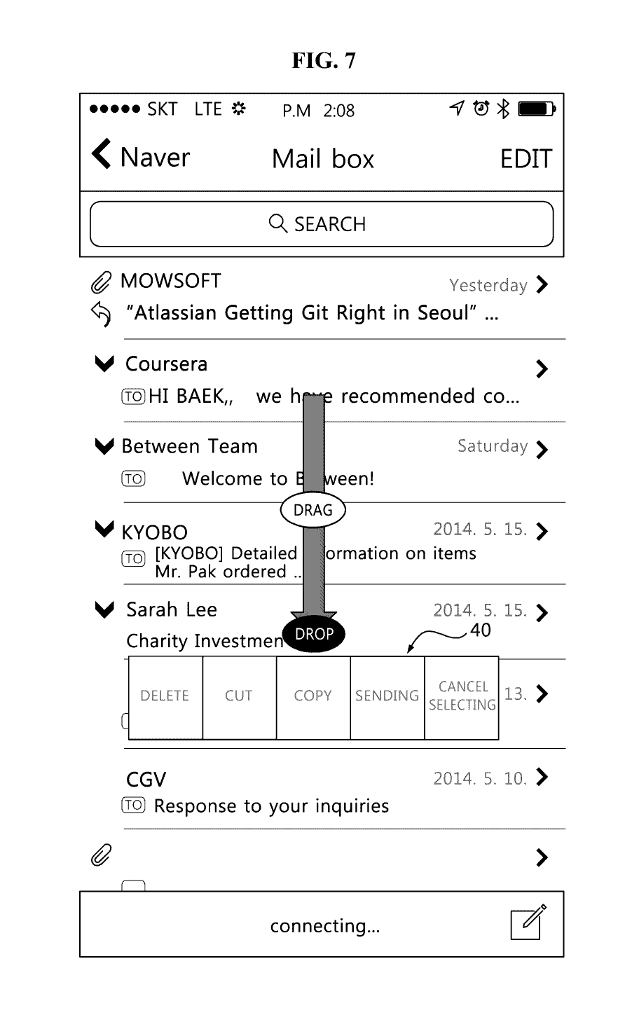

FIG. 6 is a flow chart illustrating exemplary sub-steps to carry out S400 of FIG. 1. FIG. 7 and FIG. 8 are screenshots of a touch screen display showing an exemplary execution menu that may be displayed.

Referring to FIG. 6, at step S410, an electronic device displays an execution menu 40, such as shown in FIGS. 7-8, including items that represent at least one file management function. In an exemplary embodiment, the execution menu 40 may be displayed after the electronic device receives the second input that drags in the second direction.

Referring to FIG. 7, the execution menu 40 may include an item representing a delete function to delete the target files, an item representing a cut function to cut the target files, an item representing a copy function to copy the target files, and an item representing a send function to send the target files. The execution menu 40 may further include an item representing a cancel function for canceling selection of at least one of the target files. The execution menu 40 may further include one or more items representing other function(s) or instructions to perform other processes. Moreover, items in the execution menu 40 may be modified by a user configuration option.

Referring back to FIG. 6, at step S420, the electronic device receives a third input that selects one or more of the items of the execution menu 40. The electronic device may determine one or more instructions corresponding to the selected item(s). Referring to FIG. 8, the item representing a delete function is selected by the third input from a user. The delete function may be associated with an instruction to delete corresponding files. In an exemplary embodiment, the electronic device may control the touch screen display so as to display the selected item distinctively from the other items, for example, highlighting the selected menu.

Referring back to FIG. 6, at step S430, the electronic device executes the determined instruction(s) for all the selected target files. In case of example in FIG. 8, the electronic device may execute the instruction being associated with the delete function for the target files. For example, the electronic device may request a server via one or networks to delete the target files stored in the server. For example, the electronic device may delete the target files stored in a storage medium included in the electronic device.

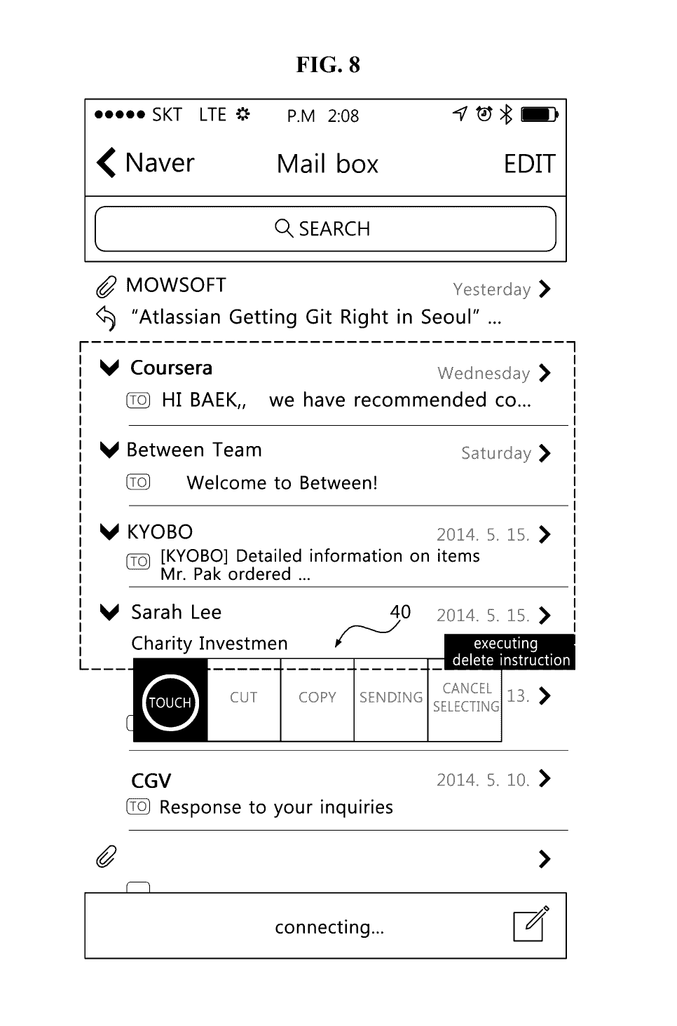

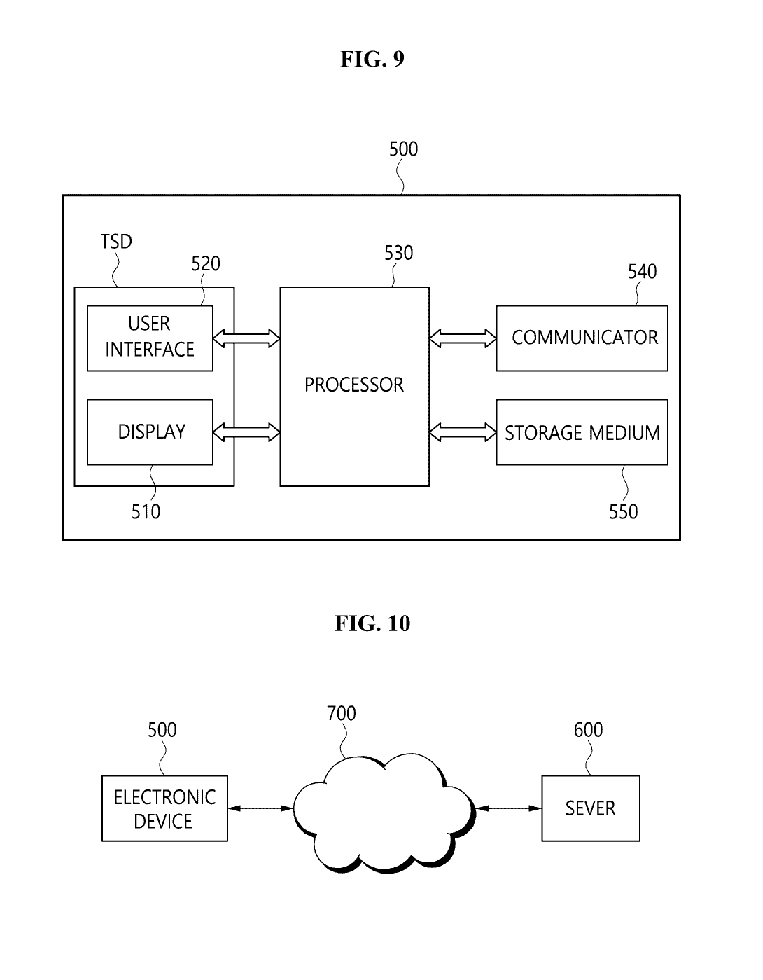

FIG. 9 is a block diagram illustrating a structure of an electronic device 500 constructed according to an exemplary embodiment of the invention. FIG. 10 is a system including the electronic device 500 and a server communicating the electronic device 500 via one or more public or private networks, such as the Internet or a virtual private network(VPN).

Referring to FIG. 9, the electronic device 500 includes a display 510, a user interface 520, a processor 530, a communicator 540, and the storage medium 550. It is contemplated that the electronic device 500 may be embodied by elements more or less than a number of the illustrated elements.

The display 510 may display information processed in accordance with instruction carried out by the processor 530. The display 510 may include at least one of a liquid crystal display, an organic light-emitting diode, a flexible display, a 3D display, an electrophoretic display, or any other display device have a GUI. The electronic device 500 may include two or more of the displays according to a specific implementation of the electronic device 500.

The user interface 520 is a device used by the user to input data to control the electronic device 500. For example, the user interface 520 may include a key pad, a dome switch, a touch pad including a capacitive overlay type, a resistive overlay type, an infrared beam type, a surface acoustic wave type, an integral strain gauge type, and a piezoelectric type, a jog wheel, a jog switch, or any other type of interfaces.

When the display 510 and the user interface 520 such as a touch pad constituting a layer structure form a touch screen display TSD, the touch screen display TSD may be used as an input device in addition to an output device.

The display 510 may display objects that generally extend in a first direction normally and generally horizontal position across the width of the display. The user interface 520 may receive a first input for causing a file selection mode and receive a second input for selecting objects as target objects. The second input may be an input that drags selected objects along the second direction transverse to the first direction in the file selection mode.

The processor 530 may control an overall operation of the electronic device 500. The processor 530 may control the display 510, the user interface 520, and the communicator 540, by executing programs stored in the storage medium 550.

The processor 530 may control the display 510 to display objects corresponding to files. The processor 530 may start to be operated as the file selection mode in response to the first input. In the file selection mode, the processor 530 may determine objects in response to the second input as target objects and control the display 510 to display the target objects in a manner that distinguishes them from the other objects. The processor 530 may simultaneously process selected files that correspond to the target objects in response to a third input. The third input may be received via the user interface 520 and indicate one or more instructions to be executed. The processor 530 may execute the indicated instruction(s) for the selected files.

The processor 530 may include a user input processing module, a service initiating module, and an execution module. The user input processing module may detect a first user input of user touching an object on the touch screen display TSD and detect a second user input of the user dragging in the second direction on the touch screen display TSD. The service initiating module may provide, in response to the first user input, a file selection mode for selecting at least two target objects. The execution module may determine target files corresponding to the target objects responsive to the second user input, determine a user instruction for simultaneously processing the target files and execute the instruction according to the user instruction. The execution module may determine, in response to a third user input, a file process instruction associated with the selected function, and process the file process instruction for the target files

The communicator 540 may include one or more constituent elements that enable communications between the electronic device 500 and an external electronic device such as a server shown in FIG. 10. For example, the communicator 540 includes a short-range wireless communicator, and a mobile communicator.

The short-range wireless communication interface may include a Bluetooth communication interface, a Bluetooth low energy (BLE) communication interface, a near field communication (NFC) unit, a WLAN (Wi-Fi) communication interface, a Zigbee communication interface, or other types of communication interfaces.

The mobile communication interface may transceive wireless signals through a mobile communication network. A wireless signal may include various types of data for transceiving text/multimedia messages.

The storage medium 550 may store programs for processing and controlling the processor 530. The programs stored in the storage medium 550 may be classified into a plurality of modules according to their functions, for example, a UI module, a touch screen module, etc. The UI module may provide a GUI for each application. The touch screen module may sense a user's gesture, such as a touch or voice command, on the touch screen display TSD and transfer information about the gesture to the processor 530.

The storage medium 550 may include at least one of a flash memory type, a hard disk type, a multimedia card micro type, a card type, etc., random access memory (RAM), static random access memory (SRAM), read-only memory (ROM), electrically erasable programmable read-only memory (EEPROM), programmable read-only memory (PROM), magnetic memory, magnetic disc, an optical disc, etc. Also, the electronic device 500 may run on a web storage or a cloud server that performs a storage function of the storage medium 550 on the Internet.

A non-transitory computer-readable storage medium storing a program executed by the processor 530 may be provided. The program may perform steps of displaying objects corresponding to first files in the touch screen display TSD, receiving a first input via the touch screen display TSD for causing a file selection mode, receiving a second input via the touch screen display TSD, displaying objects in response to the second input as target objects in the touch screen display TDS, and simultaneously processing second files corresponding to the target objects in response to a third input. The objects generally extend in a first direction, and the second input may comprise dragging one or more objects in a second direction transverse to the first direction in the file selection mode.

For example, the storage medium 550 included in the electronic device 500 may be provided as the non-transitory computer-readable storage medium. For another example, the server 600 that communicates with the electronic device 500 via a network 700 shown in FIG. 10 may be provided as the non-transitory computer-readable storage medium.

According to the exemplary embodiments, as objects representative of a files extending are selected on a TSD according to a first input comprising dragging files in a first direction and a selection of target files is determined according to a second input comprising user initiated dragging movement in a second direction generally transverse to the first direction, a user may execute a file process instruction for all the target files simultaneously and more easily, by way of seamlessly drawing a inverted“ [symbol] ” shape with the user's finger or a touch tool. In this manner, a user may control the electronic device to select and process the target objects more easily and the electronic device may operate more efficiently.

Although certain exemplary embodiments and implementations have been described herein, other embodiments and modifications will be apparent from this description. Accordingly, the inventive concept is not limited to such exemplary embodiments, but rather to the broader scope of the appended claims and various modifications and equivalent arrangements as would be recognized by the skilled artisan.

What is claimed is:

1. A method of operating an electronic device comprising a touch screen display, the method comprising the steps of:
displaying objects representative of a plurality of files, each of the objects extending generally in a first direction and arranged in a second direction intersecting the first direction;
providing a file selection mode for selecting at least two of the objects representative of files in response to receiving a first user input;
receiving a second user input that comprises the user touching the at least two objects in the second direction to determine target files; and
selecting via a third user input an instruction to be carried out simultaneously on the target files and executing the selected instruction for the target files.

2. The method of claim 1, wherein:
the first user input comprises the user touching one of the objects; and
the second user input comprises selecting at least one of the objects by dragging the at least two objects along a path in the second direction.

3. The method of claim 2, wherein the first user input comprises dragging one of the objects farther than a threshold distance in the first direction.

4. The method of claim 3, wherein the first and second user inputs comprises a continuous motion.

5. The method of claim 2, wherein the first user input comprises touching and holding one of the objects longer than a predetermined time.

6. The method of claim 2, wherein the first user input comprises touching a position of the touch screen display in a location other than the locations of the objects.

7. The method of claim 6, wherein touching the position of the touch screen display in a location other than the locations of the objects comprises touching an icon for initiating the file selection mode.

8. The method of claim 1, wherein the second user input comprises a vector element in the second direction.

9. The method of claim 1, wherein the step of selecting via a third user input an instruction to be carried out simultaneously on the target files and executing the selected instruction for the target files comprises:
displaying an execution menu including at least one item associated with a file management function corresponding to an instruction for processing the file management function for a user to select;
determining, in response to the third user input, a file process instruction associated with the selected function; and
processing the file process instruction for the target files.

10. The method of claim 9, wherein the execution menu is displayed after the conclusion of the second user input.

11. The method of claim 9, wherein the execution menu comprises at least one of an item to delete the selected files, an item to copy the selected files, and an item to send the selected files.

12. The method of claim 9, wherein the execution menu comprises an item for canceling selection of at least one of the target objects.

13. The method of claim 1, wherein the files comprise message files stored in at least one of a mailing account, a messenger service account, and a social network service (SNS) account.

14. An electronic device comprising:
a touch screen display; and
a processor configured to process an instruction for target files, each of the plurality of files including an object representative of the file and extending generally in a first direction on the touch screen display, with the plurality of objects being arranged in a second direction intersecting the first direction on the touch screen display,
wherein the processor comprises:
a user input processing module for detecting a first user input of user touching an object on the touch screen display and detecting a second user input that comprises the user touching the object in the second direction on the touch screen display;
a service initiating module for providing, in response to the first user input, a file selection mode for selecting at least two target objects from the plurality of objects; and
an execution module for determining the target files corresponding to the target objects responsive to the second user input, determining a user instruction for simultaneously processing the target files and executing the instruction according to the user instruction.

15. The electronic device of claim 14, wherein the first user input comprises dragging one of the plurality of objects farther than a threshold distance in the first direction.

16. The electronic device of claim 15, wherein the first and second user inputs comprises a continuous motion.

17. The electronic device of claim 14, wherein the first user input comprises touching and holding one of the plurality of objects longer than a predetermined time.

18. The electronic device of claim 14, wherein the second user input comprises a vector element dragging the object in the second direction.

19. The electronic device of claim 14, wherein:
the processor is configured to display an execution menu including at least one item associated with a file management function corresponding to an instruction for processing the file management function for a user to select via a third user input, and
the execution module is configured to:
determine, in response to the third user input, a file process instruction associated with the selected function; and
process the file process instruction for the target files.

20. A non-transitory computer-readable storage medium storing a program which, when executed by a computer, performs the steps of:
displaying, via a touch screen display, objects representative of a plurality of files, each of the objects extending generally in a first direction and arranged in a second direction intersecting the first direction;
providing a file selection mode for selecting at least two of the objects representative of files in response to receiving a first user input via the touch screen display;
receiving, via the touch screen display, receiving a second user input that comprises touching the at least two objects in the second direction to determine target files; and
selecting via a third user input an instruction to be carried out simultaneously on the target files and executing the selected instruction for the target files.
